(19) United States
(12) Patent Application Publication
(10) Pub. No.: US 2005/0210236 A1
(43) Pub. Date: Sep. 22, 2005

(54) Digital rights management structure, portable storage device, and contents management method using the portable storage device

(75) Inventors: Byung-rae Lee, Yongin-si (KR); Tae-sung Kim, Seoul (KR); Kyung-im Jung, Seongnam-si (KR); Yun-sang Oh, Seoul (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/085,198

(22) Filed: Mar. 22, 2005

Related U.S. Application Data
(60) Provisional application No. 60/575,757, filed on Jun. 1, 2004.

(30) Foreign Application Priority Data
Mar. 22, 2004 (KR) 10-2004-0019448

(51) Int. Cl. H04L 9/00

(52) U.S. Cl. 713/153

(57) ABSTRACT

A digital rights management (DRM) structure, a portable storage device, and a contents management method using the portable storage device are provided to facilitate the move of a rights object or encrypted content. The digital rights management structure includes a security section comprising private key information and cryptographic method which are needed to decrypt information that has been encrypted by a host device, a restriction section comprising authentication information needed for authentication with the host device and rights object information regarding content, and a data section comprising encrypted content which the host device attempts accessing.

### CROSS-REFERENCE TO RELATED APPLICATIONS

This application claims priority from Korean Patent Application No. 10-2004-0019448 filed on Mar. 22, 2004 in the Korean Intellectual Property Office and U.S. Provisional Patent Application Ser. No. 60/575,757 filed on Jun. 1, 2004 in the United States Patent and Trademark Office, the disclosures of which are incorporated herein by reference.

### BACKGROUND OF THE INVENTION

1. Field of the Invention

The present invention relates to a digital rights management (DRM) structure, a portable storage device, and a contents management method using the portable storage device. More particularly, the present invention relates to a DRM structure, a portable storage device, and a digital contents management method using the portable storage device, by which the move of a rights object or encrypted content is facilitated.

2. Description of the Related Art

Recently, digital rights management (DRM) has been actively researched and developed. Commercial services using DRM have already been used or will be used. DRM needs to be used because of the following various characteristics of digital content.

That is to say, unlike analog data, digital content can be copied without loss and can be easily reused, processed, and distributed, and only a small amount of cost is needed to copy and distribute the digital content.

However, a large amount of cost, labor, and time are needed to produce the digital content. Thus, when the digital content is copied and distributed without permission, a producer of the digital content may lose profit, and enthusiasm for creation may be discouraged. As a result, development of digital content business may be hampered.

There were several efforts to protect digital content. Conventionally, digital content protection has been concentrated on preventing non-permitted access to digital content, permitting only people paid charges to access the digital content.

Thus, people who paid charges to the digital content are allowed to unencrypted digital content while people who did not pay charges are not allowed to. In this case, when a person paid charges intentionally distributes the digital content to other people, however, the people can use the digital content without paying charges.

To solve this program, DRM was introduced. In DRM, any one is allowed to freely access encoded digital content, but a license referred to as a rights object is needed to decode and execute the digital content.

Accordingly, the digital content can be more effectively protected by using DRM.

Conception of the DRM will be described with reference to FIG. 1. DRM relates to management of contents (hereafter, referred to as encrypted contents) that are protected using a method such as encryption or scrambling and rights objects allowing access to the encrypted contents.

Referring to FIG. 1, a DRM system includes user terminals 11 and 12 wanting to access content protected by DRM, a contents issuer 13 issuing content, a rights issuer 14 issuing a rights object containing a right to access the content, and a certification authority 15 issuing a certificate.

In operation, the user terminal 11 can obtain desired content from the contents issuer 13 in an encrypted format protected by DRM. The user terminal 11 can obtain a license to play the encrypted content from a rights object received from the rights issuer 13.

Then, the user terminal 11 can play the encrypted content. Since encrypted contents can be circulated or distributed freely, the user terminal 11 can freely transmit the encrypted content to the user 12.

The user terminal 12 needs the rights object to play the encrypted content. The rights object can be obtained from the rights issuer 14.

Meanwhile, the certification authority 15 issues a certificate indicating that the contents issuer 13 is authentic and the user terminals 11 and 12 are authorized. The certificate may be embedded into devices used by the user terminals 11 and 12 when the devices are manufactured and may be reissued by the certification authority 15 after a predetermined duration has expired.

DRM protects the profits of those producing or providing digital contents and thus may be helpful in activating the digital content industry.

However, there is inconvenience practically although a rights object or encrypted content can be transferred between the user terminals 11 and 12 using mobile devices.

Thus, it is necessary to easily move a rights object or encrypted content between devices. When a portable storage device is used, a rights object and encrypted content can be easily moved between devices.

### SUMMARY OF THE INVENTION

The present invention provides a DRM structure facilitating the move of a rights object or encrypted content through a nonvolatile memory, a portable storage device, and a contents management method using the portable storage device.

According to an aspect of the present invention, there is provided a digital rights management structure including a security section comprising private key information and cryptographic method which are needed to decrypt information that has been encrypted by a host device, a restriction section comprising authentication information needed for authentication with the host device and rights object information regarding content, and a data section comprising encrypted content which the host device attempts accessing.

The digital rights management structure may further comprise a system section comprising identifier information by which the host device identifies a portable storage device connected thereto.

The authentication information may include at least one among public key information of a certification authority, public key information of a portable storage device connected with the host device, the portable storage device's certificate information signed with a digital signature of the certification authority, and certificate revocation list information.

The certification authority's public key information may be used to decrypt a certificate of the host device.

The portable storage device's public key information may be used by the host device to encrypt information to be transmitted to the portable storage device.

The portable storage device's certificate information and the certificate revocation list information may be used to verify whether the host device and the portable storage device are authentic during authentication between the host device and the portable storage device.

The rights object information may include at least one among a definition of a right to the encrypted content, constraints to the right, and a right to a rights object itself.

According to another aspect of the present invention, there is provided a portable storage device including a nonvolatile memory storing encrypted content, rights object information regarding the content, and authentication information needed for authentication with a host device, and an access controller selectively permitting the host device to access the nonvolatile memory according to a result of the authentication.

The portable storage device may further include a work processor processing over-all work related to the authentication with the host device and the access of the host device.

The nonvolatile memory may include a system section comprising identifier information by which the host device identifies the portable storage device, a security section comprising private key information and cryptographic method information that are needed to decrypt information encrypted by the host device, a restriction section comprising the authentication information needed for the authentication with the host device and the rights object information regarding the content, and a data section comprising the encrypted content which the host device attempts to access.

According to still another aspect of the present invention, there is provided a method of managing contents using a portable storage device, including performing authentication between the portable storage device and a host device, and selectively permitting access of the host device to a nonvolatile memory included in the portable storage device according to a result of the authentication.

The selectively permitting of the access may comprise, after completion of the authentication, receiving from the host device a request for access to at least one among predetermined encrypted content, rights object information regarding the content, and authentication information.

The host device may request the predetermined encrypted content based on a list of encrypted contents stored in the nonvolatile memory of the portable storage device and an ID of the predetermined encrypted content.

The access to the nonvolatile memory is permitted while the host device may be accessing at least one among the predetermined encrypted content, the rights object information regarding the content, and the authentication information.

According to yet another aspect of the present invention, there is provided a method of managing contents using a portable storage device, comprising performing authentication between the portable storage device and a host device, after completion of the authentication, receiving from the host device a request to update authentication information and rights object information, and permitting access of the host device while updating the authentication information and the rights object information.

The updated authentication information may include at least one among public key information of a certification authority, public key information of a portable storage device connected with the host device, the portable storage device's certificate information signed with a digital signature of the certification authority, and certificate revocation list information.

The method of managing contents may further include, after the updating, converting a mode for the access of the host device into a read-only mode.

### BRIEF DESCRIPTION OF THE DRAWINGS

The above and other aspects of the present invention will become more apparent by describing in detail exemplary embodiments thereof with reference to the attached drawings in which:

FIG. 1 is a conceptual diagram of general digital rights management (DRM);

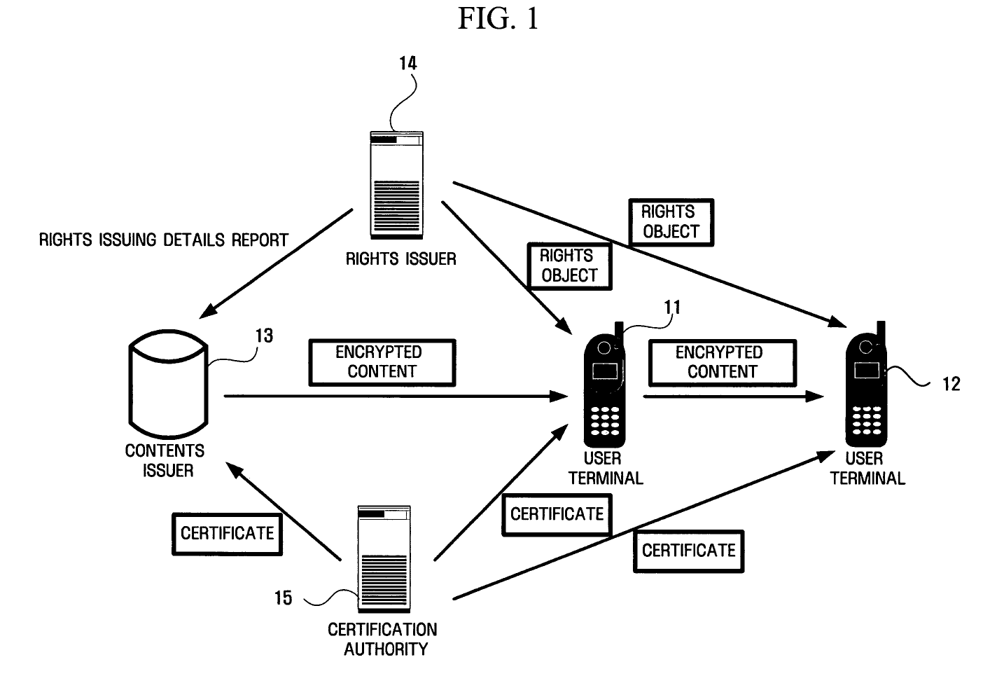

FIG. 2 is a conceptual diagram of DRM according to an exemplary embodiment of the present invention;

FIG. 3 is a block diagram of a portable storage device according to an exemplary embodiment of the present invention;

FIG. 4 is a DRM structure of a nonvolatile memory according to an exemplary embodiment of the present invention;

FIG. 5 is a flowchart of a contents management method using a portable storage device according to an exemplary embodiment of the present invention;

FIG. 6 is a diagram illustrating an authentication procedure according to an exemplary embodiment of the present invention; and

FIG. 7 is a flowchart of a method of updating authentication information according to an exemplary embodiment of the present invention.

### DETAILED DESCRIPTION OF THE EXEMPLARY EMBODIMENTS

The present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these embodiments are provided so that this disclosure will be thorough and complete and will fully convey the concept of the invention to those skilled in the art, and the present invention will only be defined by the appended claims. Like reference numerals refer to like elements throughout the specification.

The present invention will now be described more fully with reference to the accompanying drawings, in which exemplary embodiments of the invention are shown.

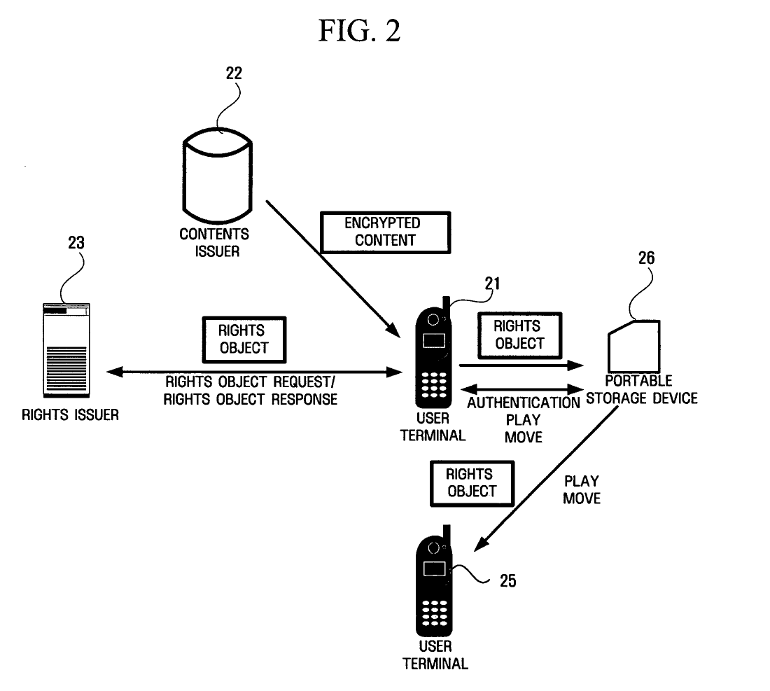

FIG. 2 is a conceptual diagram of digital rights management (DRM) according to an exemplary embodiment of the present invention.

Referring to FIG. 2, a user terminal 21 can obtain encrypted content from a contents issuer 22.

The encrypted content is content protected through DRM. To play the encrypted content, a rights object for the encrypted content is needed.

A rights object contains a definition of a right to content or constraints to the right and a right to the rights object itself. An example of the right to the content may be a playback. Examples of the constraints may be the number of playbacks, a playback time, and a playback duration. An example of the right to the rights object may be move or copy. In other words, a rights object containing a right to move or copy may be moved or copied to another device through a portable storage device 26.

The portable storage device 26 used in exemplary embodiments of the present invention includes a nonvolatile memory such as a flash memory that can read, write, and erase data and indicates a storage device that can be connected with a device.

The portable storage device 26 may be a smart media card, a memory stick, a compact flash (CF) card, an XD-picture card, or a multimedia card but is not restricted thereto.

The user terminal 21 obtained the encrypted content may request a rights object from a rights issuer 23 to obtain a right to play. When the user terminal 21 receives the rights object together with a rights object response from the rights issuer 23, the user terminal 21 can play the encrypted content using the rights object.

Meanwhile, the user terminal 21 may transmit the rights object to a user terminal 25 having a corresponding encrypted object via the portable storage device 26.

For example, the portable storage device 26 may be a secure multimedia card having a DRM function. In this case, the user terminal 21 transmits the rights object to the secure multimedia card after mutual authentication.

When playing encrypted content, the user terminal 21 may request a right to play from the portable storage device 26 and receive the right to play, i.e., a content encryption key, from the portable storage device 26. Then, the user terminal 21 can play the encrypted content using the content encryption key.

Meanwhile, after performing authentication with the user terminal 25, the portable storage device 26 can move a rights object to the user terminal 25 or enable the user terminal 25 to play encrypted content.

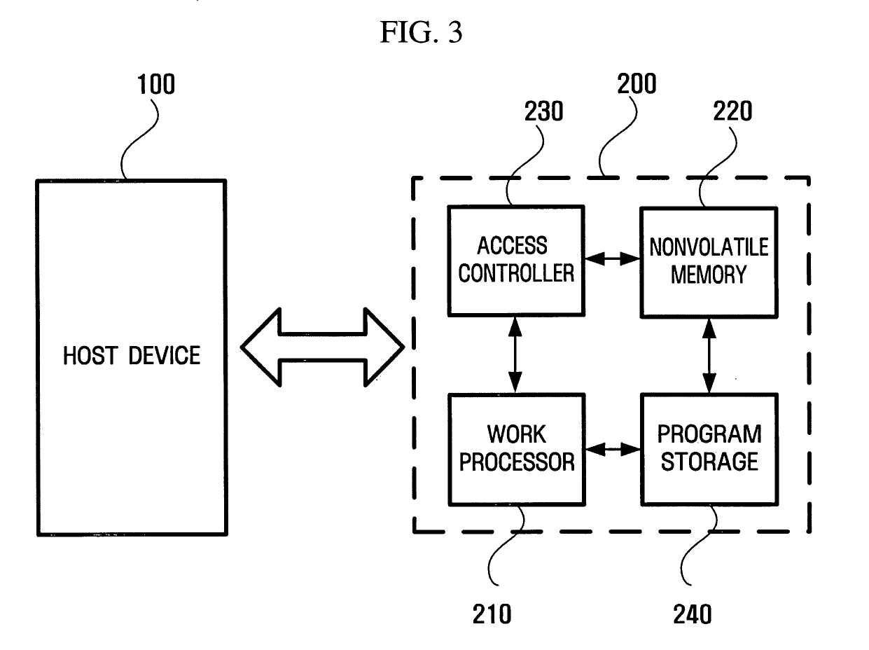

FIG. 3 is a block diagram of a portable storage device 200 according to an exemplary embodiment of the present invention.

As shown in FIG. 3., the portable storage device 200 includes a work processor 210 that processes over-all work related to authentication with a predetermined host device 100 and access of the host device 100 to encrypted content; a nonvolatile memory 220 that stores the encrypted content and authentication information needed for the authentication; and an access controller 230 that is controlled by the work processor 210 to access the encrypted content in the host device 100.

In addition, the portable storage device 200 may further include a program storage 240 that stores a driving program needed to operate the portable storage device 200.

In detail, the program storage 240 may store a driving program for driving various encryption methods, for example, RSA, advanced encryption standard (AES), and data encryption standard (DES).

The program storage 240 may further store a driving program for other operations such as move and copy of encrypted content that can be performed by the portable storage device 200 in addition to the driving program for the encryption methods.

The work processor 210 may include a control processing unit (CPU), a rights object, and an input/output unit. The work processor 210 may serve to transfer information between the host device 100 and the access controller 230.

The access controller 230 may restrictively permit the host device 100 to access encrypted content stored in the nonvolatile memory 220.

In detail, the access controller 230 may determine whether to permit an access of the host device 100 according to a result of determining whether the host device 100 is authentic through authentication between the portable storage device 200 and the host device 100.

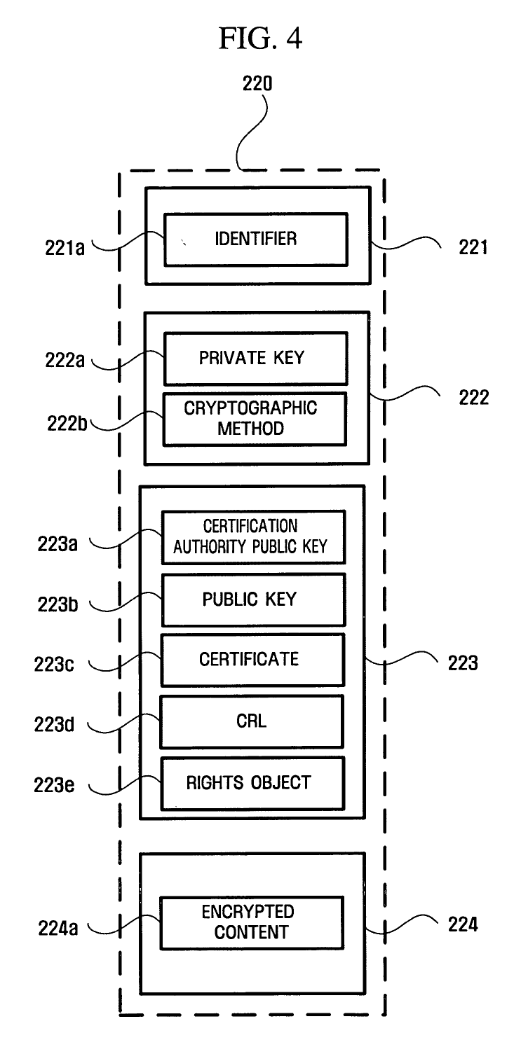

Referring to FIG. 4, the nonvolatile memory 220 includes a system section 221 including identifier information 221a by which the host device 100 identifies the portable storage device 200, a security section 222 including private key information 222a of the portable storage device 200 and cryptographic method informatiotn 222b, a restriction section 223 including authentication information needed for authentication with the host device 100, and a data section 224 storing encrypted content 224a.

The restriction section 223 may include certification authority's public key information 223a needed for authentication with the host device 100, portable storage device's public key information 223b, portable storage device's certificate information 223c signed with a digital signature of the certification authority, certificate revocation list (CRL) information 223d, and rights object information 223e.

The certification authority's public key information 223a is used to decrypt a certificate of the host device 100.

The portable storage device's public key information 223b is used by the host device 100 to encrypt information to be transmitted to the portable storage device 200.

The portable storage device's certificate information 223c and the CRL information 223d are used to verify whether the host device 100 and the portable storage device 200 are authentic during authentication.

The rights object information 223e contains a definition of a right to the encrypted content 224a, constraints to the right, and a right to a rights object itself.

An access to the restriction section 223 may be selectively restricted by the access controller 230.

For example, the identifier 221a included in the system section 221 and the portable storage device's private key information 222a and the cryptographic method information 222b included in the security section 222 are unique information possessed by the portable storage device 200. Accordingly, for security, an access of the host device 100 to the unique information may be interrupted. Alternatively, the unique information may be stored in a separate memory.

As another alternative, when an update of the portable storage device's certificate information 223c is needed due to expiration thereof or when an update of the CRL information 223d is needed, an access of the host device 100 may be selectively permitted. 75Generally, to prevent the CRL information 223d and the rights object information 223e to be modified or deleted by another device, an access of the host device 100 thereto may be totally interrupted.

For such interruption of an access, the CRL information 223d and the rights object information 223e may be encrypted and stored.

Meanwhile, the portable storage device's public key information 223b may be set to read-only since it may be published.

The data section 224 is an area in which the encrypted content 224a to which the host device 100 actually intends to access is stored.

The same elements as the elements 210, 220, 230, and 240 included in the portable storage device 200 may be included in the host device 100.

Accordingly, authentication between the host device 100 and the portable storage device 200 becomes possible.

The following description concerns a contents management method using the portable storage device 200 according to an exemplary embodiment of the present invention.

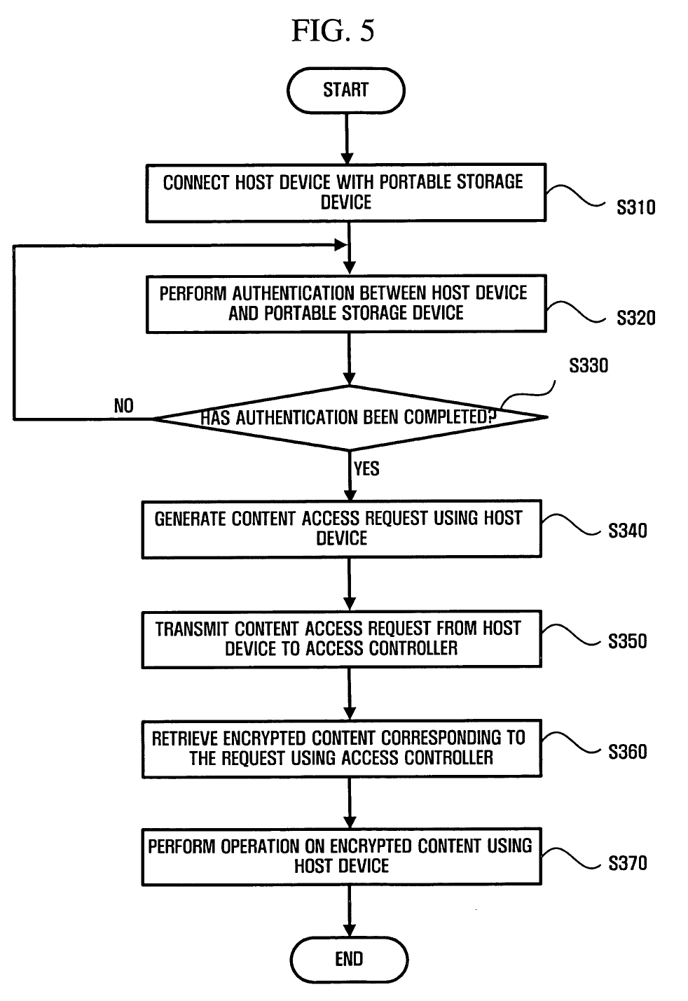

Referring to FIG. 5, in operation S310, the portable storage device 200 is connected with the host device 100.

When the portable storage device 200 is connected with the host device 100, an interface unit of the portable storage device 200 is electrically connected with an interface unit of the host device 100. However, this is just an example, and “being connected” simply implies that two devices can communicate with each other through a wireless medium in a non-contact state.

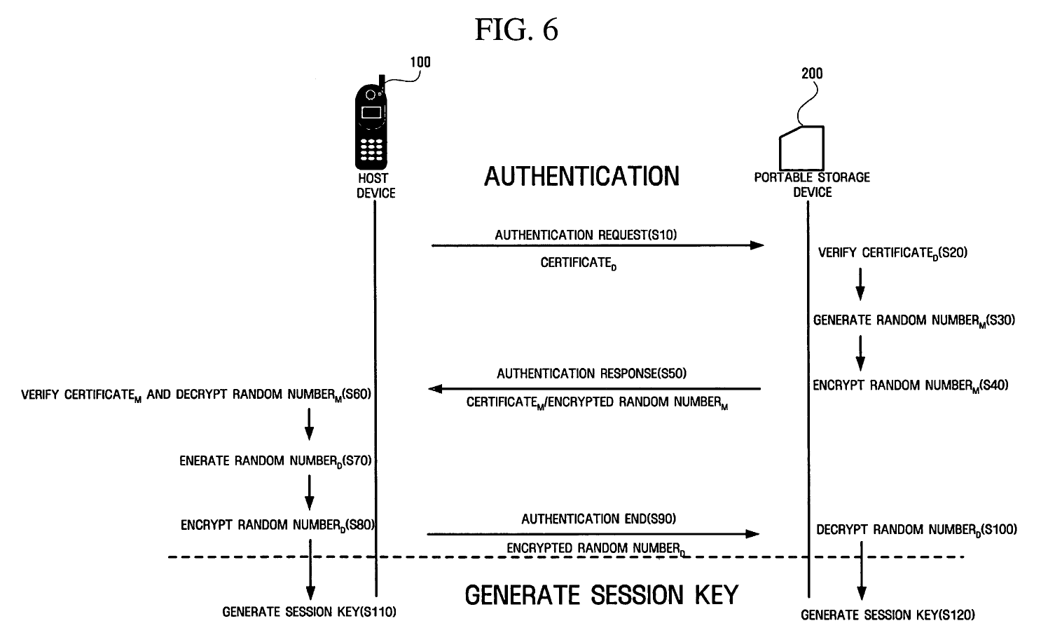

In operation S320, the host device 100 and the portable storage device 200 perform an authentication procedure. The authentication procedure will be described in detail with reference to FIG. 6.

Authentication is a procedure in which the host device 100 and the portable storage device 200 authenticate each other's genuineness and exchange random numbers for generation of a session key. A session key can be generated using a random number obtained during authentication.

In FIG. 6, descriptions above arrowed lines relate to a command requesting another device to perform a certain operation and descriptions below the arrow-headed lines relate to a parameter needed to execute the command or data transported. A subscript “D” of an object indicates that the object is possessed or generated by a device and a subscript “M” of an object indicates that the object is possessed or generated by a portable storage device.

In an exemplary embodiment of the present invention, the host device 100 issues all commands for the authentication and the portable storage device 200 performs operations needed to execute the command.

For example, the host device 100 may send a command such as an authentication response to the portable storage device 200. Then, the portable storage device 200 sends a certificateM and an encrypted random number_{M} to the host device 100 in response to the authentication response.

In another exemplary embodiment of the present invention, both of the host device 100 and the portable storage device 200 may issue commands.

For example, the portable storage device 200 may send the authentication response together with the certificate_{M} and the encrypted random number_{M} to the host device 100. Detailed descriptions of the authentication procedure will be set forth below.

In operation S10, the host device 100 sends an authentication request to the portable storage device 200.

When requesting authentication, the host device 100 sends a host device public key_{D} to the portable storage device 200.

For example, the host device public key_{D} may be sent by sending a host device certificate_{D} issued to the host device 100 by a certification authority.

The host device certificate_{D} is signed with a digital signature of the certification authority and contains a host device ID and the host device public key_{D}.

Based on the host device certificate_{D}, the portable storage device 200 can authenticate the host device 100 and obtain the host device public key_{D}.

In operation S20, the portable storage device 200 verifies whether the host device certificate_{D} is valid using a CRL.

If the host device certificates_{D} is registered in the CRL, the portable storage device 200 may reject the authentication with the host device 100.

If the host device certificates_{D} is not registered in the CRL, the portable storage device 200 obtains the host device public key_{D} using the host device certificated.

In operation S30, the portable storage device 200 generates a random number_{M}. In operation S40, the random number_{M} is encrypted using the host device public key_{D}.

In operation S50, an authentication response procedure is performed by sending an authentication response from the host device 100 to the portable storage device 200 or from the portable storage device 200 to the host device 100.

During the authentication response procedure, the portable storage device 200 sends a portable storage device public key_{M} and encrypted random number_{M} to the host device 100.

In an exemplary embodiment of the present invention, instead of the portable storage device public key_{M}, a portable storage device certificate_{M} may be sent to the host device 100.

In another exemplary embodiment of the present invention, the portable storage device 200 may send its digital signature_{M} to the host device 100 together with the encrypted random number_{M} and the portable storage device certificate_{M}.

In operation S60, the host device 100 receives the portable storage device certificate_{M} and the encrypted random number_{M}, authenticates the portable storage device 200 by verifying the portable storage device certificate_{M}, obtains the portable storage device public key_{M}, and obtains the random number_{M} by decrypting the encrypted random number_{M} using the host device public key_{D}.

In operation S70, the host device 100 generates a random number_{D}. In operation S80, the random number_{D} is encrypted using the portable storage device public key_{M}.

Thereafter, an authentication end procedure is performed in operation S90 where the host device 100 sends the encrypted random number_{D} to the portable storage device 200.

In an exemplary embodiment of the present invention, the host device 100 may send its digital signature_{D} to the portable storage device 200 together with the encrypted random number_{D}.

In operation S 100, the portable storage device 200 receives and decrypts the encrypted random number_{D}.

In the exemplary embodiment, since both the host device 100 and the portable storage device 200 generate their own random numbers and use each other's random numbers, randomness can greatly increase and secure mutual authentication is possible. In other words, even if one of the host device 100 and the portable storage device 200 has weak randomness, the other of them can supplement randomness.

In exemplary embodiments of the present invention, a random number may be generated using a random number generation module (not shown). Alternatively, a random number may be one number selected from a plurality of numbers stored in a device or a secure MMC or a combination of multiple numbers selected therefrom. In addition, a random number may not only be a numeral but a character string. Accordingly, a random number may indicate a number, a combination of numbers, or a character string that is generated using a random number generation module, or may indicate one number, a combination of multiple numbers, one character string, or a combination of multiple character strings selected from a plurality of numbers or character strings stored previously.

In operations S110 and S120, the host device 100 and the portable storage device 200 that share each other's random numbers generates their session keys using both of their two random numbers.

To generate a session key using the two random numbers, an algorithm that has been published may be used. A simplest algorithm is performing an XOR operation of two random numbers.

Once the session keys are generated, diverse operations protected by DRM can be performed between the host device 100 and the portable storage device 200.

When the authentication has been completed in operation S330, the host device 100 sends a request to access predetermined encrypted content to the portable storage device 200.

Here, the host device 100 may search encrypted contents stored in the data section 224 and then request desired encrypted content. Alternatively, the host device 100 may request an access to the desired encrypted content using an ID of the desired encrypted content that is known in advance.

In operation S350, the content access request of the host device 100 is transmitted to the access controller 230.

In operation S360, the access controller 230 retrieves encrypted content corresponding to the content access request from the data section 224.

In operation S370, the host device 100 performs an operation on the encrypted content.

After the host device 100 completes the operation on the encrypted content, the access controller 230 may restrict the access of the host device 100.

In another exemplary embodiment, information stored in the portable storage device 200 may be updated, which will be described below.

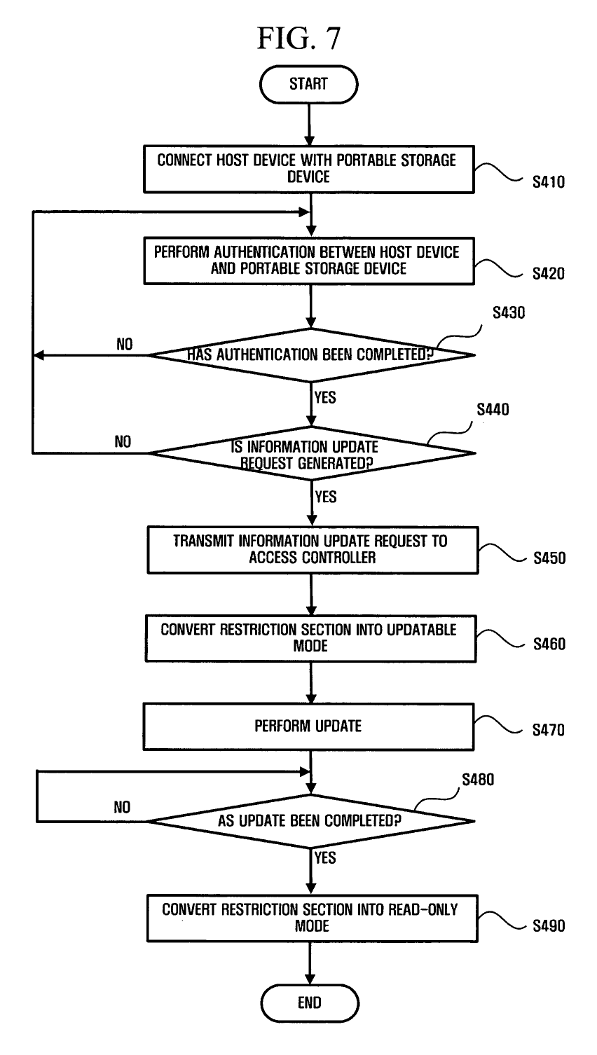

FIG. 7 is a flowchart of a method of updating authentication information included in the restriction section 223 among information stored in the portable storage device 200, according to an exemplary embodiment of the present invention.

Referring to FIG. 7, in operation S410, the portable storage device 200 is connected with the host device 100. In operation S420, the host device 100 and the portable storage device 200 perform an authentication procedure. Here, the authentication procedure illustrated in FIG. 6 may be performed.

When the authentication has been completed in operation S430, the host device 100 generates an information update request in operation S440. Then, in operation S450, the work processor 210 transmits the information update request to the access controller 230.

In operation S460, in response to the information update request, the access controller 230 converts an access setting of the restriction section 223 from a read-only mode into an updatable mode.

Thereafter, in operation S470, the host device 100 accesses the restriction section 223 and updates the portable storage device's certificate information 223c.

When the update of the portable storage device's certificate information 223c is completed in operation S480, the access controller 230 converts the access setting into the read-only mode to prevent other host devices from accessing the restriction section 223 without permission in operation S490.

Although the digital rights management structure, the portable storage device, and the method of managing contents using the portable storage device according to the present invention have been described with reference to the exemplary embodiments thereof, it will be understood that the invention is not limited to the details thereof. Rather, various substitutions and modifications have been suggested in the foregoing description, and other will occur to those of ordinary skill in the art. Therefore, all such substitutions and modifications are intended to be embraced within the scope of the invention as defined in the appended claims.

As described above, according to the present invention, a rights object and encrypted content can be easily moved through a portable storage device, and therefore, the convenience of users using the encrypted content is increased.

1. A digital rights management structure comprising:
a security section comprising private key information and cryptographic method information which are utilized to decrypt information that has been encrypted by a host device;
a restriction section comprising authentication information utilized for authentication with the host device and rights object information regarding content; and
a data section comprising encrypted content which the host device attempts accessing.

2. The digital rights management structure of claim 1, further comprising a system section comprising identifier information which is utilized by the host device to identify a portable storage device connected to the host device.

3. The digital rights management structure of claim 2, wherein the authentication information comprises at least one of public key information of a certification authority, public key information of a portable storage device connected with the host device, certificate information signed of the portable storage device with a digital signature of the certification authority, and certificate revocation list information.

4. The digital rights management structure of claim 3, wherein public key information of the certification authority is used to decrypt a certificate of the host device.

5. The digital rights management structure of claim 4, wherein the public key information of the portable storage device is used by the host device to encrypt information to be transmitted to the portable storage device.

6. The digital rights management structure of claim 5, wherein the certificate information of the portable storage device and the certificate revocation list information are used to verify whether the host device and the portable storage device are authentic during authentication between the host device and the portable storage device.

7. The digital rights management structure of claim 6, wherein the rights object information comprises at least one of a definition of a right to the encrypted content, constraints to the right to the encrypted content, and a right to a rights object.

8. A portable storage device comprising:
a nonvolatile memory which stores encrypted content, rights object information regarding the content, and authentication information utilized for authentication with a host device; and
an access controller which selectively permits the host device to access the nonvolatile memory according to a result of the authentication.

9. The portable storage device of claim 8, further comprising a work processor which processes work related to the authentication with the host device and the access of the host device.

10. The portable storage device of claim 9, wherein the nonvolatile memory comprises:
a system section comprising identifier information utilized by the host device to identify the portable storage device;
a security section comprising private key information and cryptographic method information that are utilized to decrypt information encrypted by the host device;
a restriction section comprising the authentication information utilized for the authentication with the host device and the rights object information regarding the content; and
a data section comprising the encrypted content which the host device attempts to access.

11. The portable storage device of claim 10, wherein the authentication information comprises at least one of public key information of a certification authority, public key information of the portable storage device connected with the host device, certificate information of the portable storage device signed with a digital signature of the certification authority, and certificate revocation list information.

12. The portable storage device of claim 11, wherein public key information of the certification authority is used to decrypt a certificate of the host device.

13. The portable storage device of claim 12, wherein public key information of the portable storage device is used by the host device to encrypt information to be transmitted to the portable storage device.

14. The portable storage device of claim 13, wherein certificate information of the portable storage device and the certificate revocation list information are used to verify whether the host device and the portable storage device are authentic during authentication between the host device and the portable storage device.

15. The portable storage device of claim 14, wherein the rights object information comprises at least one of a definition of a right to the encrypted content, constraints to the right to the encrypted content, and a right to a rights object.

16. A method of managing contents using a portable storage device, the method comprising:
performing authentication between the portable storage device and a host device; and
selectively permitting access of the host device to a nonvolatile memory included in the portable storage device according to a result of the authentication.

17. The method of claim 16, wherein the selectively permitting of the access comprises, after completion of the authentication, receiving from the host device a request for access to at least one of predetermined encrypted content, rights object information regarding the content, and authentication information.

18. The method of claim 17, wherein the host device requests the predetermined encrypted content based on a list of encrypted contents stored in the nonvolatile memory of the portable storage device and an ID of the predetermined encrypted content.

19. The method of claim 18, wherein the access to the nonvolatile memory is permitted while the host device is accessing at least one of the predetermined encrypted content, the rights object information regarding the content, and the authentication information.

20. A method of managing contents using a portable storage device, the method comprising:
performing authentication between the portable storage device and a host device;
after completion of the authentication, receiving from the host device a request to update authentication information and rights object information; and
permitting access of the host device while updating the authentication information and the rights object information.

21. The method of claim 20, wherein the updated authentication information includes at least one of public key information of a certification authority, public key information of a portable storage device connected with the host device, certificate information of the portable storage device signed with a digital signature of the certification authority, and certificate revocation list information.

22. The method of claim 21, further comprising, after the updating, converting a mode for the access of the host device into a read-only mode.
